(19) United States
(12) Patent Application Publication
(10) Pub. No.: US 2025/0182585 A1
(43) Pub. Date: Jun. 5, 2025

(54) SYSTEMS AND METHODS FOR DYNAMIC CONTEST ALLOCATION AND PROCESSING

(71) Applicant: DK Crown Holdings Inc., Boston, MA (US)

(72) Inventors: Yuriy Gerzon, North Easton, MA (US); Luke Carey, Buffalo, NY (US); Jeffrey Finch, Walnut Creek, CA (US); Nicola Atorino, Malta (IT); Eric Beauregard, Dracut, MA (US); Jacqueline Quill, Lancaster, MA (US); Corey Batt, New York, NY (US); Charles Gershman, Minnetonka, MN (US); Evan Kreshtool, Melrose, MA (US); Andrew Busch, Needham, MA (US)

(73) Assignee: DK Crown Holdings Inc., Boston, MA (US)

(21) Appl. No.: 18/961,968

(22) Filed: Nov. 27, 2024

Related U.S. Application Data
(60) Provisional application No. 63/605,411, filed on Dec. 1, 2023.

(51) Int. Cl. G07F 17/32

(52) U.S. Cl. CPC G07F 17/3288; G07F 17/323; G07F 17/3262

(57) ABSTRACT

Described herein are systems and methods for dynamic contest allocation and processing. A data processing system can maintain contests corresponding to one or more live sporting events. The data processing system can maintain historic data identifying historical outcomes of historical fantasy sports lineups. The data processing system can receive a request identifying a player profile and a fantasy sports lineup. The data processing system can select a subset of candidate contests from the contests. The data processing system can determine, based on the historic data, estimated outcomes for the fantasy sports lineup when entered into the subset of the candidate contests. The data processing system can provide an indication of the estimated outcomes for the fantasy sports lineup.

### CROSS-REFERENCES TO RELATED APPLICATIONS

This application claims the benefit of and priority to U.S. Provisional Patent Application No. 63/605,411, filed Dec. 1, 2023, the contents of which is incorporated herein by reference in its entirety for all purposes.

### BACKGROUND

Providing synchronized information is useful for networked computing environments including multiple computing systems. Information can be shared using different formats or protocols. It is challenging to provide synchronized information efficiently in computing systems via computer networks having different types of computing devices.

### SUMMARY

The systems and methodologies outlined in this technical solution offer mechanisms for synchronized information exchange among multiple computing devices, enabling the delivery of timely notifications, alerts, or additional content related to live events. Given their real-time requirements, it can be challenging to efficiently and accurately transmit up-to-date information about network events across multiple computing devices, such as between servers and client devices accessing these servers. This technical solution addresses these and other challenges by implementing synchronized data frameworks within network communication sessions. These synchronized data frameworks can incorporate metadata to enhance the efficiency and accuracy of data transfer between computing devices, even in computing environments with a large number of devices.

At least one aspect of the present disclosure is directed to a system. The system can include one or more processors coupled to non-transitory memory. The system can maintain a set of contests corresponding to one or more live sporting events. The system can receive, from a client device, a request. The request can identify a player profile and a fantasy sports lineup. The system can select, based on the set of contests and the fantasy sports lineup, a subset of the set of contests in which the fantasy sports lineup is to be entered. The system can determine a set of outcomes for the fantasy sports lineup across the subset of contests based on a corresponding outcomes of the one or more live sporting events and corresponding entrants for the subset of contests. The system can provide, to the client device, an indication of an award amount for the fantasy sports lineup determined based on the set of outcomes.

At least one aspect of the present disclosure is directed to a method. The method can include maintaining, by one or more processors coupled to non-transitory memory, a set of contests corresponding to one or more live sporting events. The method can include receiving, by the one or more processors form a client device, a request identifying a player profile and a fantasy sports lineup. The method can include selecting, by the one or more processors, based on the set of contests and the fantasy sports lineup, a subset of the set of contests in which the fantasy sports lineup is to be entered. The method can include determining, by the one or more processors, a set of outcomes for the fantasy sports lineup across the subset of contests based on corresponding outcomes of the one or more live sporting events and corresponding entrants for the subset of contests. The method can include providing, by the one or more processors to the client device, an indication of an award amount of the fantasy sports lineup determined based on the set of outcomes.

At least one aspect of the present disclosure is directed to a system. The system can include one or more processors coupled to non-transitory memory. The system can maintain a set of contests corresponding to one or more live sporting events. The system can maintain historic data identifying a set of historical outcomes of a plurality of historical fantasy sports lineups. The system can receive, from a client device, a request identifying a player profile and a fantasy sports lineup. The system can select, based on the set of contests and the fantasy sports lineup, a subset of candidate contests from the set of contests. The system can determine, based on the historic data, a set of estimated outcomes for the fantasy sports lineup when entered into the subset of the candidate contests. The system can provide, to the client device, an indication of the set of estimated outcomes for the fantasy sports lineup.

At least one aspect of the present disclosure is directed to a method. The method can include maintaining, by one or more processors coupled with memory, a set of contests corresponding to one or more live sporting events. The method can include maintaining, by the one or more processors, historic data identifying a set of historical outcomes of a set of historical fantasy sports lineups. The method can include receiving, by the one or more processors from a client device, a request identifying a player profile and a fantasy sports lineup. The method can include selecting, by the one or more processors, based on the set of contests and the fantasy sports lineup, a subset of candidate contests from of the set of contests. The method can include determining, by the one or more processors, based on the historic data, a set of estimated outcomes for the fantasy sports lineup when entered into the subset of the candidate contests. The method can include providing, by the one or more processors, to the client device, an indication of the set of estimated outcomes for the fantasy sports lineup.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form. For example, by appropriate computer programs, which may be carried on appropriate carrier media (e.g., computer readable media), which may be tangible carrier media (e.g., disks) or intangible carrier media (e.g., communications signals). Aspects may also be implemented using suitable apparatuses, which may take the form of programmable computers running computer programs arranged to implement the aspect. As used in the specification and in the claims, the singular form of “a”, “an”, and “the” include plural referents unless the context clearly dictates otherwise.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 illustrates a block diagram of an example system for dynamic contest allocation and processing in a client-server configuration, in accordance with one or more implementations;

FIGS. 2A, 2B, 2C, 2D, and 2E illustrate a graphical user interfaces for dynamic contest allocation and processing, in accordance with one or more implementations;

FIG. 3 illustrates an example flow diagram of a method for dynamic contest processing, in accordance with one or more implementations;

FIG. 4 illustrates an example flow diagram of a method for dynamic contest allocation, in accordance with one or more implementations; and

FIG. 5 illustrates a block diagram of a server system and a client computer system in accordance with an illustrative implementation.

### DETAILED DESCRIPTION

Below are detailed descriptions of various concepts related to, and implementations of, techniques, approaches, methods, apparatuses, and systems for dynamic contest allocation and processing. The various concepts introduced above and discussed in greater detail below may be implemented in any of numerous ways, as the described concepts are not limited to any particular manner of implementation. Examples of specific implementations and applications are provided primarily for illustrative purposes.

The techniques described herein include features and functionalities to select contests for entry based on a lineup selected by a player, and to generate estimated outcomes for the selected contests. These features may include but are not limited to display mechanics, visual and audio elements, intuitive user interfaces, dynamic game environments, and contest systems. The techniques can be applied to various live sporting event contests, including fantasy sports contests, which may correspond to any type of event such as racing, football, chess, basketball, baseball, tennis, golf, hockey, award shows, games shows, among others. Moreover, the techniques discussed herein allow players to engage in informed contest entry across to improve player engagement and outcomes. The techniques described herein can be used to automatically select contests in a manner that reduces overall computational complexity and network bandwidth utilization relative to other techniques, while compensating for rapidly-changing statistics and states of each contest. Moreover, the techniques described herein can be used to automatically select contests in a manner that significantly reduces overall computational complexity and network bandwidth utilization relative to other techniques. This is achieved by employing advanced algorithms that efficiently process and analyze changing statistics and states of each contest.

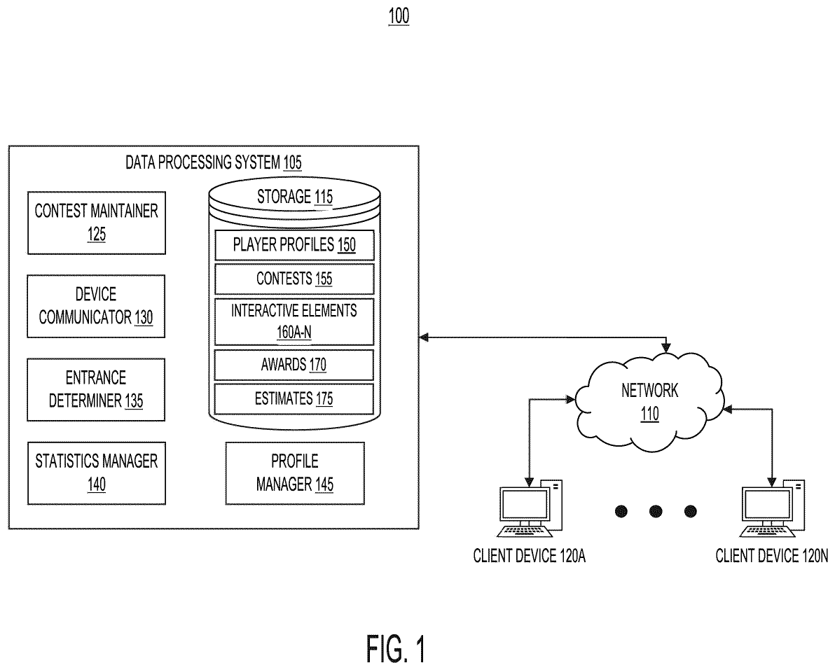

Referring to FIG. 1, depicted is a block diagram of an example system 100 for providing graphical user interfaces for participation in contests relating to live events. In FIG. 1, the system 100 can include at least one data processing system 105, at least one network 110, and one or more client devices 120A-120N (sometimes generally referred to as client device(s) 120).

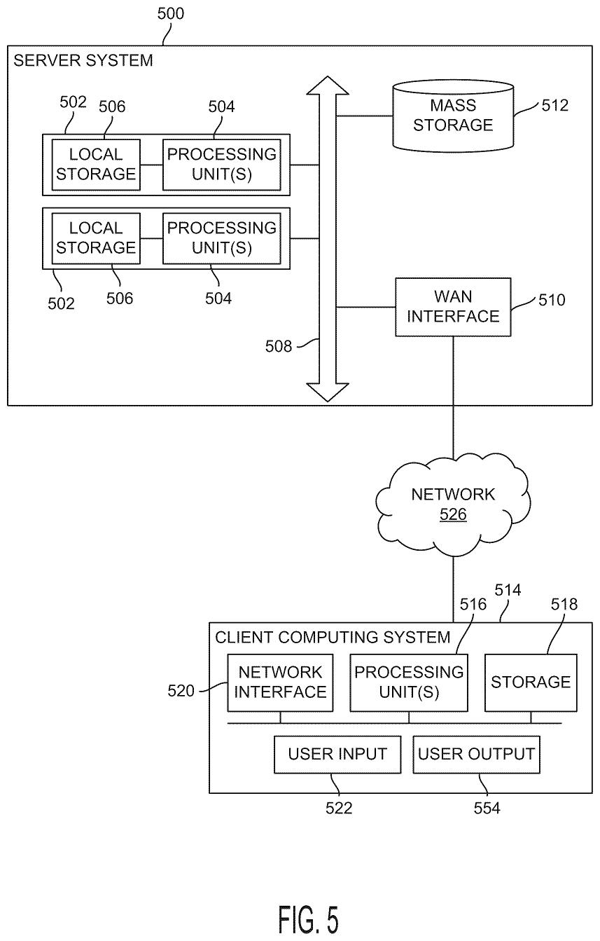

In FIG. 1, the data processing system 105 can include at least one contest maintainer 125, at least one device communicator 130, at least one entrance determiner 135, at least one statistics manager 140, at least one profile manager 145, and at least one storage 115. The storage 115 can include one or more player profiles 150, one or more contests 155, one or more interactive elements 180A-N (sometimes generally referred to as the interactive elements 180), one or more awards 170, and one or more estimates 175. Each of the components (e.g., the data processing system 105, the network 110, the client devices 120, etc.) of the system 100 can be implemented using the hardware components or a combination of software with the hardware components of a computing system, such as the server 500 or the client computing system 514 described in connection with FIG. 5, or any other computing system described herein.

The data processing system 105 can include at least one processor and a memory, e.g., a processing circuit. The memory can store processor-executable instructions that, when executed by processor, cause the processor to perform one or more of the operations described herein. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105 can include one or more computing devices or servers that can perform various functions as described herein. The data processing system 105 can include any or all of the components and perform any or all of the functions of a server system 500 described herein in conjunction with FIG. 5.

The network 110 can include computer networks such as the Internet, local, wide, metro or other area networks, intranets, satellite networks, other computer networks such as voice or data mobile phone communication networks, and combinations thereof. The data processing system 105 of the system 100 can communicate via the network 110, for example with one or more client devices 120. The network 110 may be any form of computer network that can relay information between the data processing system 105, the one or more client devices 120, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks.

The network 110 may also include any number of computing devices (e.g., computers, servers, routers, network switches, etc.) that are configured to receive and/or transmit data within the network 110. The network 110 may further include any number of hardwired and/or wireless connections. Any or all of the computing devices described herein (e.g., the data processing system 105, the one or more client devices 120, the server system 500, the client computing system 514, etc.) may communicate wirelessly (e.g., via WiFi, cellular, radio, etc.) with a transceiver that is hardwired (e.g., via a fiber optic cable, a CAT5 cable, etc.) to other computing devices in the network 110. Any or all of the computing devices described herein (e.g., the data processing system 105, the one or more client devices 120, the server system 500, the client computing system 514, etc.) may also communicate wirelessly with the computing devices of the network 110 via a proxy device (e.g., a router, network switch, or gateway).

Each of the client devices 120 can include at least one processor and a memory, e.g., a processing circuit. The memory can store processor-executable instructions that, when executed by processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client devices 120 can include one or more computing devices or servers that can perform various functions as described herein. The one or more client devices 120 can include any or all of the components and perform any or all of the functions of the client computing system 514 described herein in conjunction with FIG. 5.

Each client device 120 can include, but is not limited to, a mobile device (e.g., a smartphone, tablet, etc.), a television device (e.g., smart television, set-top box, et.), a personal computing device (e.g., a desktop, a laptop, etc.) or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, a display, etc.) and one or more input/output (I/O) devices (e.g., a mouse, a keyboard, digital keypad). The display can include one or more portions, for example, to display multiple interactive elements as described herein. The display can include a touch screen displaying an application, such as the contest applications described herein. The display can include a border region (e.g., side border, top border, bottom border).

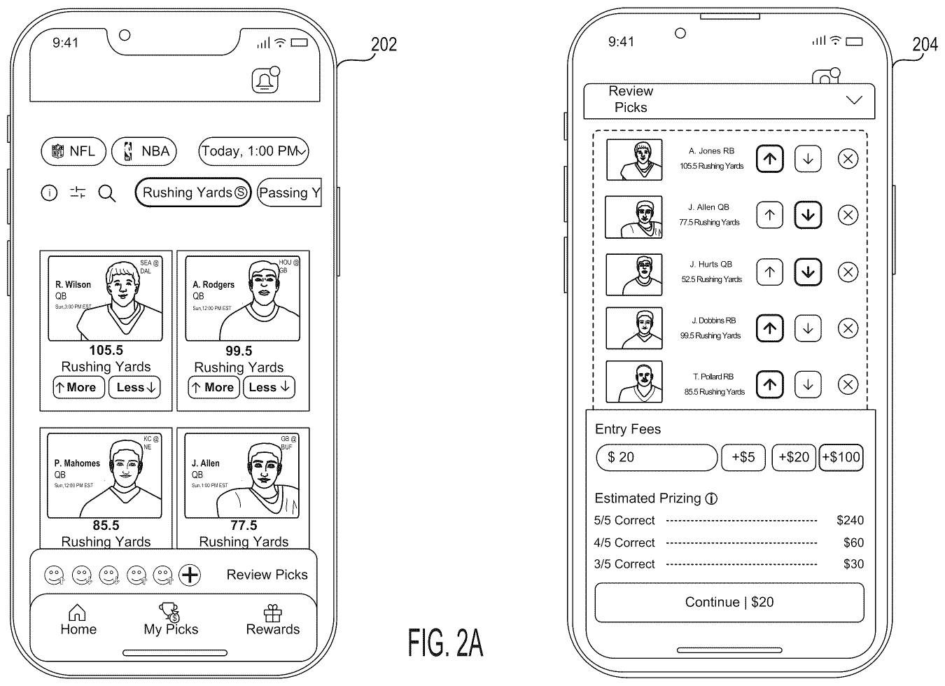

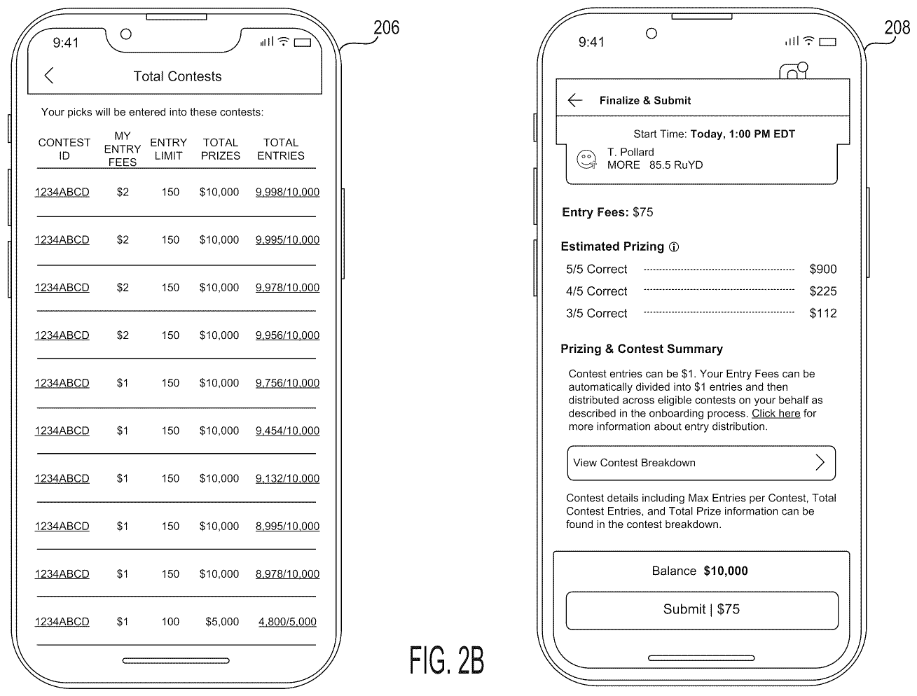

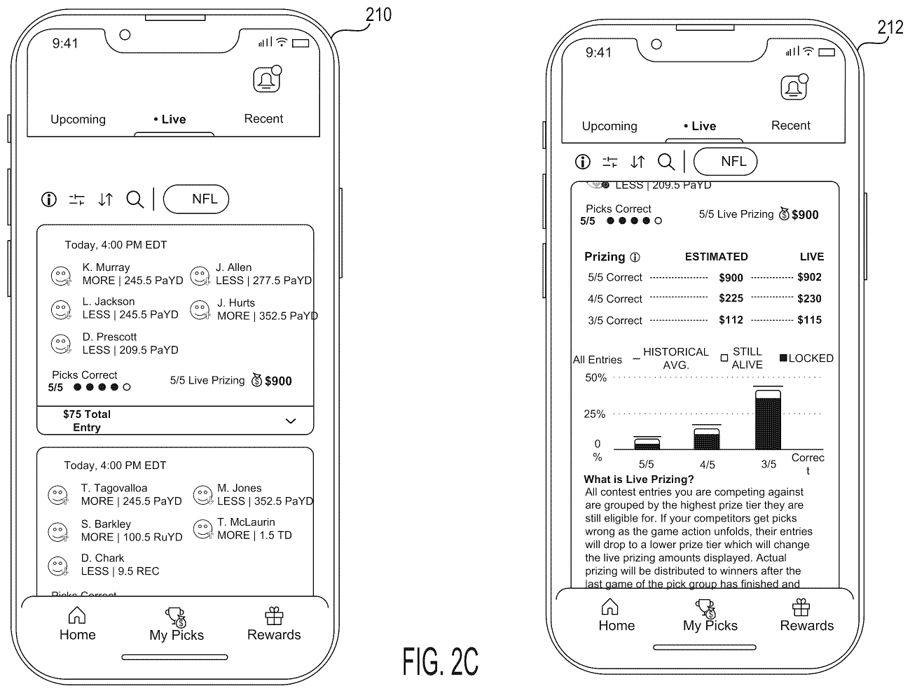

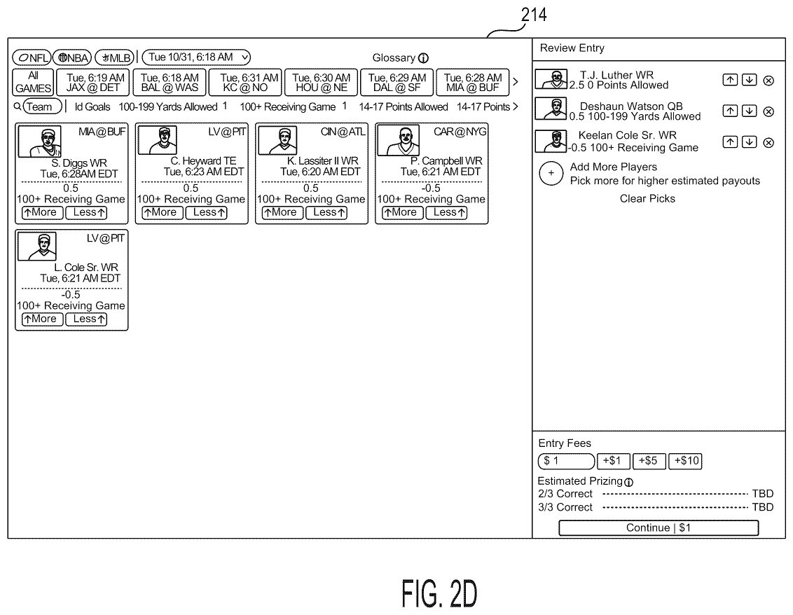

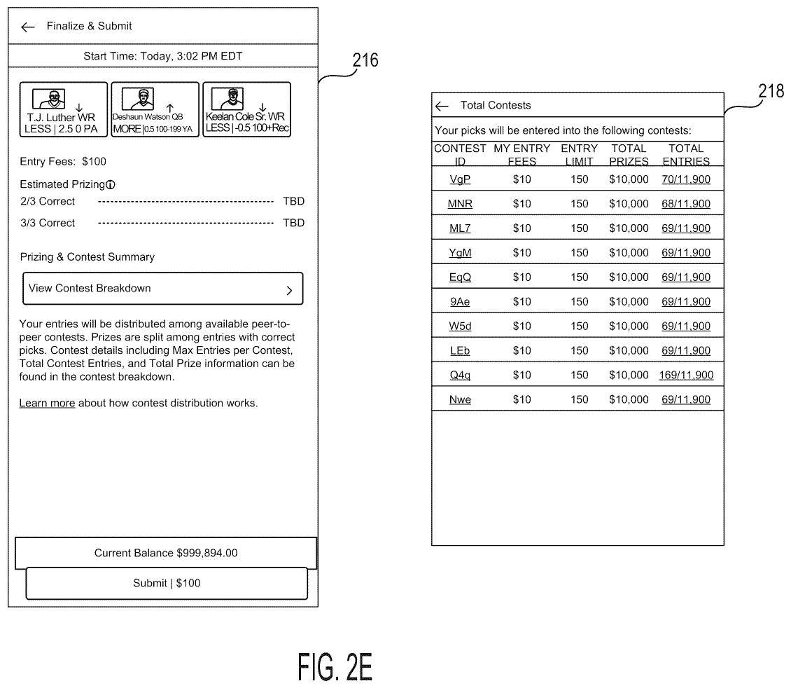

In some implementations, the display can include a touch screen display, which can receive interactions from a player. Touchscreens are becoming increasingly popular as they offer a more intuitive way to interact with devices. Touchscreens may include displays that present graphical user interfaces, which may include icons, buttons, and other graphical elements that can be interacted with by touching the screen. For example, as shown in FIGS. 2A-2E, the graphical user interface can display game graphics, interactive objects, and other relevant information that players need to interact with the data processing system 105.

The interactions can result in interaction data, which can be stored and transmitted by the processing circuitry of the client device 120. The interaction data can include, for example, interaction coordinates, an interaction type (e.g., click, swipe, scroll, tap, etc.), and an indication of an actionable object with which the interaction occurred. Each client device 120 can include an input device that enables a player to interact with and/or select one or more actionable objects as described herein. For example, a touchscreen display can enable interaction with one or more visual indications provided through the display of each mobile device 120, and responsive to an interaction (e.g., select, click-on, touch, hover), the client device 120 can generate an indication identifying a player input and/or selection of a contest, a live event, or a lineup, among others.

Each client device 120 can include a device identifier, which can be specific to each respective client device 120. The device identifier can include a script, code, label, or marker that identifies a particular client device 120. In some implementations, the device identifier can include a string or plurality of numbers, letters, characters or any combination numbers, letters, and characters. In some implementations, each client device 120 can have a unique device identifier. Each client device 120 can include a client application, which can be a contest application that communicates with the data processing system 105 to submit entry fees for fantasy sports contests, as described herein. The client application can include an application executing on each client device 120 or provided to the client device 120 by the system.

The application can include a web application, a server application, a resource, a desktop, or a file. In some implementations, the application can include a local application (e.g., local to a client device 120), hosted application, Software as a Service (SaaS) application, virtual application, mobile application, and other forms of content. In some implementations, the application can include or correspond to applications provided by remote servers or third-party servers. In some implementations, the application can access the player profiles 150, the contests 155, the interactive elements 180, the awards 170, or the estimates 175, stored and maintained at the storage 115, and generate one or more user interfaces, such as the user interfaces described herein below in connection with FIGS. 2A-2E, to a player through a client device 120. Such user interfaces can include player-selectable hyperlinks, buttons, graphics, videos, images, or other application features that generate a signal that is processed by the application executing on the respective client device 120.

In implementations, one or more client devices 120 can establish one or more communication sessions with the data processing system 105. The one or more communication sessions can each include a channel or connection between the data processing system 105 and the one or more client devices 120. The one or more communication systems can each include an application session (e.g., virtual application), an execution session, a desktop session, a hosted desktop session, a terminal services session, a browser session, a remote desktop session, a URL session and/or a remote application session. Each communication session can include encrypted and/or secure sessions, which can include an encrypted file, encrypted data or traffic. The client devices 120 can each use the communication session established with the data processing system 105 to carry out any of the functionalities described herein. For example, the application executing on a client device 120 can perform any of the client-side operations described herein, including determining any of the estimates 175 described herein, or presenting indications of the estimates or awards 170 through any of the user interfaces shown in FIGS. 2A-2E, or any other types of user interfaces described herein.

Each of the client devices 120 can be computing devices configured to communicate via the network 110 to access information resources, such as web pages via a web browser, or application resources via a native application executing on a client device 120. When accessing information resources, the client device can execute instructions (e.g., embedded in the native applications, in the information resources, etc.) that cause the client devices to display contest application interfaces, such as the user interface described herein below in conjunction with FIGS. 2A-2E. The contest application interfaces can be, for example, application interfaces that present different contests 155, fantasy sports lineups including entries, or outcomes associated with one or more lives events. In general, live event contest applications include content (e.g., images, video, animations, graphics, audio, etc.) that is presented to a player via the input/output interfaces of a client device 120.

In some implementations, the live event contest applications can present a selectable list of live events (e.g., current or upcoming sporting events, etc.) or live event categories (e.g., teams, particular sports or event types, etc.). Upon selection of a live event in the list, or upon a receiving a selection of a lineup, the data processing system 105 can provide one or more user interfaces similar to the user interfaces shown in FIGS. 2A-2E, which enable a user to select one or more combinations of selected entries for one or more lineups for one or more contests, as described herein. Upon receiving one or more selections of entries, the data processing system 105 can generate one or more lineup of the entries which may be entered into a subset of the contests 155. The lineup of entries may be presented on the application interfaces presented at the respective client device.

In response to interaction with user interface elements, the client devices 120 can transmit information, such as player profile information (e.g., changing player profile parameters, changing login information, any information stored in a player profile 150, etc.), interaction information, selections of contest entry amounts, selections of lineups, selections of live events, or other signals to the data processing system 105. In some implementations, a client device 120 can transmit a request to initiate a contest entry session, and requests for additional contest entry features during a contest entry session. The request can be a hypertext transfer protocol (HTTP or HTTPS) request message, a file transfer protocol message, an email message, a text message, or any other type of message that can be transmitted via the network 110.

The data processing system 105 is shown as including the storage 115. The storage 115 can be a computer-readable memory that can store or maintain any of the information described herein. The storage 115 can maintain one or more data structures, which may contain, index, or otherwise store each of the values, pluralities, sets, variables, vectors, numbers, or thresholds described herein. The storage 115 can be accessed using one or more memory addresses, index values, or identifiers of any item, structure, or region maintained in the storage 115. The storage 115 can be accessed by the components of the data processing system 105, or any other computing device described herein, via the network 110. In some implementations, the storage 115 can be internal to the data processing system 105. In some implementations, the storage 115 can exist external to the data processing system 105 and may be accessed via the network 110. For example, the storage 115 may be distributed across many different computer systems (e.g., a cloud computing system) or storage elements and may be accessed via the network 110 or a suitable computer bus interface.

The data processing system 105 can store, in one or more regions of the memory of the data processing system 105, or in the storage 115, the results of any or all computations, determinations, selections, identifications, generations, constructions, or calculations in one or more data structures indexed or identified with appropriate values. Any or all values stored in the storage 115 may be accessed by any computing device described herein, such as the data processing system 105, to perform any of the functionalities or functions described herein. In implementations where the storage 115 forms a part of a cloud computing system, the storage 115 can be a distributed storage medium in a cloud computing system and can be accessed by any of the components of the data processing system 105, by the one or more client devices 120 (e.g., via the user interface similar to that depicted in FIGS. 2A-2E, etc.), or any other computing devices described herein.

The storage 115 can store one or more player profiles 150 associated with a user (referred to herein as a “player”) of a client device 120. A player profile 150 of a player can be a user profile that includes information about the player and information about one or more of the client devices 120 used to access the data processing system 105 using the player profile 150. For example, identifiers of the player profile 150 can be used to access the functionality of the data processing system 105 (e.g., by logging into the data processing system 105 via one or more web-based interfaces). The identifiers can include a username, a password, an e-mail address, a phone number, a personal identification number (PIN), a secret code-word, device identifiers for use in a two-factor authentication technique, among others.

The player profile 150 can store information about currently entered lineups, current contests, historic contests, live events, and selections that are performed by the player via the data processing system 105. The player profile 150 can store a credit balance, contest information. The player profile 150 can store information about a client device used to access the data processing system 105 such as an IP address, a MAC address, a GUID, a player profile name (e.g., the name of a user of the client device 120, etc.), device name, among others. In some implementations, the player profile 150 can be created by the data processing system 105 in response to a player profile creation request transmitted by a client device 120. The player profile creation request can include any of the player profile information described herein.

In some implementations, a client device 120 accessing the data processing system 105 may not be associated with a player profile 150. In such implementations, the data processing system 105 can automatically create a player profile 150 using an identifier of the client device 120 provided by the client device 120. The player profile 150 can store a credit balance or contest entry information (e.g., contests entered that have not yet started, contests entered that have started, outcomes associated with current or historic contests, lineup entrants for the contests, timestamps associated with said lineups and/or contests, a client device identifier of a client device that was used to submit a lineup to the contest 155, the number of contests 155 entered using the player profile 150, the number of lineups entered into various contests 155, etc.). The player profile 150 can store and update a counter value based on one or more lineups generated via communications with the data processing system 105 or an outcome of a contest.

The storage 115 can store or maintain contests 155 accessible to one or more player profiles 150 through the application operating on the client device 120. The contest 155 can be or include be any game, competition, fantasy draft, or other such event that enables one or more players to compete against each other with a player-submitted lineup of entries, based on live events. Contests 155 can be generated at least by the system 100, by a player, or by an external system. Contests 155 can be based around live events. Live events can include, for example, a tennis match, a football game, sub-events of a football game such as which athlete will score the first touchdown, which team will score the first goal, which team has more fouls, which athlete will score the second touchdown, which team will win the game, or which team will have a greater score at halftime, rushing yards performed by an athlete during a football game, points scored by one or more athletes or teams during a sporting event, or any other type of event or condition that may occur during a live sporting event. It should be understood that other events are also possible for live events (e.g., baseball games, hockey games, basketball games, other types of live events, etc.) Furthermore, other sub-events for the aforementioned live events are also possible.

For example, a contest 155 can include rules and contests based upon the duration, sub-events and outcome of a football or other sports game, of a specific period/quarter/half of a sports game, passes thrown or received by participants in a sports game, or other sub-events of a live event or the live event itself. A contest of the one or more contests 155 can be selected by a player via the device communicator 130. Contests 155 can be updated periodically, such as daily, weekly, or according to a schedule of live events. Contests can be updated by the contest maintainer 125. Available contests can be contests visible to or accessible for entrance by a player via a client device 120. Contests 155 can be made unavailable due to at least a time limit expiring, sub-events within the live event occurring, the live event ending, the contest being previously entered by the player, a conflicting contest already having been entered, or a threshold amount of participants already entered into the contest. In some embodiments, not all contests are available to all players. For example, a contest can be made available only for players who have a received a virtual entrance ticket, allowance, code, right, etc., or for players who have selected a lineup of a number or type of entries corresponding to one or more rules of the contest for number or types of entries.

In some embodiments, contests 155 into which a player has entered a lineup can be visible by other players via the network 110. Each player entered into a contest can be seen, viewed, or otherwise identifiable by other players entered into at least the same contest, subject to permissions specified by the player and stored in a corresponding player profile. Any number of players can enter one or more respective lineups into a contest to compete amongst each other. In this manner, a lineup generated by a first player can be in competition with, and may share awards with, one or more lineups generated by one or more other players in a peer-to-peer contest system. For example, outcomes (e.g., award amounts for lineup selections) for players with lineup entered into one or more contests can be determined based on other lineups entered into the contest by other players participating in the peer-to-peer contest system. Entering a contest can refer to submitting a lineup to that particular contest. A player can generate a lineup by selecting one or more entries to populate the lineup. The entries can be or include cards, tags, or tokens associated with live events. In some implementations, the entries can correspond to one or more athletes, teams, point spreads, or scores. For example, an entry can include a selection between over or under a score for a live event, over or under a score for predetermined sub-event of the live event (e.g., half-time, a shootout, etc.), whether a sub-event will occur, among others. For example, the entries can be or include athlete cards corresponding to a player profile 150.

The player may select the lineup via the interactive elements 160A-N (hereinafter generally referred to as the interactive element(s) 160) stored in the storage 115. The storage 115 can store or maintain interactive elements 160. The interactive elements 160 can include one or more interactive elements for display via one or more graphical user interfaces. In some implementations, the interactive elements 160 may include instructions or parameters for generating such interactive user interface elements, which may be displayed in graphical user interfaces such as the graphical user interfaces of FIGS. 2A-2E. The interactive elements 160 can include one or more user interface elements to accept input or display output via the client device 120. For example, the interactive elements 160 can include one or more buttons, switches, toggles, sliders, text boxes, drop down menus, or other such user interface elements, such as those described in reference to the user input 522 of FIG. 5 at least. In some implementations, the interactive elements 160 may include or cause execution of executable instructions, interpretable scripts, or commands that cause a client device 120 to generate and display interactive user interface elements, as described herein.

The interactive elements 160 can include interactive elements to select one or more fantasy sports lineups. The player may select, using one or more of the interactive elements 160, one or more entries to generate the lineup. In some cases, one or more interactive elements 160 may correspond to a respective entry for the contests 155 stored in association with the player profile 150. For example, a user interface (such as the user interfaces described with reference to FIGS. 2A-2E) can display a listing of entries associated with a player profile 150 of the player. The player may select, via the user interface presenting on the client device 120, one or more entries to generate a lineup.

The interactive elements 160 can include interactive elements to input an entry fee to automatically enter the generated lineup into multiple contests 155. For example, the player may enter an amount of money, tokens, or another type of entry amount or fee to automatically enter the lineup into one or more contests 155. In some cases, the entry fee amount can correspond to a number of seats of a contest into which the lineup may be entered. For example, $1 may correspond to one seat of a contest. A seat of the contest can refer to or include a participant of the contest. In some cases, seats of a contest 155 can be limited. A player may enter one or more lineups into a contest based on the number of seats in the contest. For example, a player may enter the same contest with the same lineup once or more. By entering a contest once or more, a player may earn a proportional amount of an award of the contest. As an illustrative example, in a contest with ten seats, a player may submit the same lineup twice. If five seats of the contest win, including the player's two seats, the player is eligible for ⅖ or 40% of the winnings, in one example, based on the outcomes of other players that entered said contest. In some cases, seats may be limited by player. For example, a player may not enter over a threshold number of lineups into the same contest. In this manner, the player may diversify which contests he or she is entered into.

The entry fee may be divided across one or more contests 155. In some cases, the entry fee may be evenly split among each contest which the player enters the generated lineup into. For example, the entry fee amount may be divided by the number of contests into which the player has entered or will enter the lineup. In some cases, the entry fee amount may be split among each contest into which the player enters based on a proportion of seats that the player has entered in each contest. In some cases, the entry fee amount may be divided among the contests which the player enters the generated lineup into based on a round-robin approach. For example, a portion of the entry fee amount may be allocated to each contest based on a sequence of the contests until the wager has been fully allocated. In some cases, the entry fee amount may be used to buy seats of a contest. For example, a seat may have a cost associated with it, and the entry fee amount entered by the player via the interactive elements 160 may be used to purchase entrance to a contest by purchasing seats of the contest.

The interactive elements 160 can include options for automatic entry into one or more active contests 155, and any actions (e.g., interactions, pausing/waiting for a particular duration at stored timestamps, etc.) the client device 120 takes in response to said options. In some implementations, the interactive elements or their corresponding components (e.g., entries, lineups, or entry fees) can change responsive to a change in the live event, an option taken by a player, or an action by the client device 120. In addition, the interactive elements 160 can include information relating to the conditions of additional contests.

The entry fee amount may relate to an award 170. The award 170 can be or include tokens, entries (such as athletes, teams, etc. to enter into a lineup), money, or another prize given to a player through the contest application for winning, placing, or otherwise fulfilling a criteria of one or more contests into which the player has entered the generated lineup. The award 170 can be determined based on the outcomes of a player's selected entries for a lineup that is automatically entered into one or more active contests 155. In some implementations, a larger entry fee permits additional contests to be selected for automatic entry. Furthering this example, a larger entry fee may enable a larger award 170 than a smaller entry fee, by virtue of the player's lineup being entered into a greater number of contests 155 or a greater number of seats of the contests 155. The award 170 given to a player can be based on respective outcomes of each contest in which the player's lineup is automatically entered, the outcomes of each entry in said lineup, the outcomes of other players' lineups in each contest in which the player's lineup is entered, or a combination thereof.

For example, a first outcome of a first entry in a lineup entered to a first contest can correspond to a threshold score associated with a first team participating in a live event, and a second outcome of a second entry in the lineup entered into a second contest can include a score associated with a second team participating in the live event. As another example, the first outcome can relate to a Walks and Hits Per Inning Pitched (WHIP) for a first starting pitcher of a live baseball game and a WHIP for a second starting pitcher of the live baseball game. The award 170 can be determined at the conclusion of a live event, or prior to the conclusion of a live sporting event, if the outcome for the selected entry has been determined or will not change.

In some cases, the award 170 or an estimate 175 can be dependent on the entry fee and each lineup entered into each respective contest. The estimate 175 can be or include a possible award for a contest 155. The estimate 175 and the award 170 can be per seat of a contest 155, per contest 155, or a summed award 170 or estimate 175 for a generated lineup within contests 155. The estimate 175 can be generated based on odds information associated with the live event, such as historic odds of the live event.

The outcome of a particular lineup entered into a particular contest can be ranked among outcomes of other lineups entered into the contest 155 to determine the award 170 for the particular lineup. The ranking can correspond to the award 170 or the estimate 175. For example, there may be a first award associated with first place winners of a contest and a second award associated with second place winners of a contest. A first place winner of a contest can correspond to a lineup entered into a contest in which each entry of the lineup satisfies a winning criteria of the contest (e.g., each entry of the lineup is correct, scores an indicated number of points, plays for an indicated amount of time, etc.). In some cases, a first place winner of a contest can correspond to a particular lineup in which more entries satisfy the winning criteria of the contest than entries of other lineups entered into the contest. In some cases, the award 170 can be dispersed to a loser of the contest 155. For example, a last place seat of a contest may earn one or more awards 170. In this manner, participation in contests can invoke competition between other players of the contests. Furthermore, the contests 155 can be considered contests between peers, such as between players entering the contests.

The estimate 175 or the award 170 can be determined based on other lineups currently entered into the contest. For example, award 170 for a particular lineup entered into a particular contest can be conditional on the lineups entered by other players for the particular contest. For a particular contest, the quantity of lineups, the entrants of those lineups, the seats occupied by each lineup, among others, can affect the award 170 or estimate 175 of a particular lineup entered by a player for the particular contest. In some cases, a particular lineup which earned a second place ranking could have resulted in a first, third, or other place outcome, based on the lineups entered by other participants of the contest. For example, a particular lineup can result in wins for only two out of five entries of the lineup, but if other lineups entered by other players into the contest result in wins for only one or zero of the entries of their respective lineups, the particular lineup can place first. Furthermore, awards for each contest can be affected by the variety of players of the contest and their respective lineups. As an example, when an amount of lineups corresponding to a multitude of players wins a particular contest, the award for each winner of the particular contest is inversely proportional to the amount of winning players. In this manner, peer-to-peer competition can be a component of the contest system.

The interactive elements 160 can include, or may include instructions for generating, odds information, which can be stored within a data structure of the contest 155 as probability values of certain events occurring during a live event. The odds information may further define one or more probability distributions that may be sampled to determine an outcome of one or more events in the live event. In some implementations, the odds information may be altered based on actions taken by the player, or the odds information can correspond to the likelihood of one or more outcomes (e.g., an expected value of player loss, an expected value of player win, etc.). For example, in a live football game, the odds of an athlete reaching the 50 yard line within a period of time may determine an award 170 or an estimate 175 of an award that the player wins if that event occurs.

The estimates 175 can include or be based on live event information (e.g., current statistics associated with the live event, players participating in the live event, scores of the live event, etc.) for one or more lineups entered into the contest 155 provided via the data processing system 105. In some implementations, information used to update the estimates 175 can be received as the live event occurs or prior to the occurrence of the live event (e.g., as the live event or events related to the live event are processed by the data processing system 105). For example, the odds corresponding to a particular contest 155 or all contests 155 that a player has entered the lineup into may be updated responsive to a change in the live event (e.g., an athlete injury, a goal scored, an athlete substitution, etc.). The estimate 175 may be generated based on the odds updated during the live event. The odds for a particular contest 155 may be established by the system 100, an external system, or a combination thereof. In some cases, the system 100, an external system, or a combination thereof can determine the odds using data from one or more live events. Odds for a particular contest 155 be determined, calculated, or otherwise established by statistical analyses performed on historical data relating to a type of the live event, teams of the live event, an athlete of the live event, historical odds of lineups for the type of live event, historical odds of the live event, among others. The estimate 175 can be determined based on at least these odds, such that the estimate 175 can be based on historic data identifying historical outcomes of a historical fantasy sports lineups. In some cases, the system 100 can determine the odds for one or more of the contests 155 using data from one or more other contests 155, player profiles 150, or odds for similar live events or contests.

In some implementations, the estimates 175 for one or more events or live events can be determined using historical data from similar events. Events deemed similar for estimates 175 can include past events with the same numbers of participants, the same quantity of correct lineups or lineup entries, or a comparable payout structure. The historical data considered for the estimated 175 can include the number of players who participated in similar events, the quantity of correct lineup entries each player made, and the corresponding payouts awarded, among others. By analyzing the historical data, the system 100 can determine an average payout based on how players in past similar events performed.

In some implementations, the estimates 175, contests 155, or the interactive elements 160 can include information related to the live event, such as a team name, athlete name, overall standing of a team, current score of the live event, current statistics of the live event, outcomes of prior live events associated with a team or player of the current live event, a favorite or underdog of the live event, among others. The contests 155 may display the information related to the live event, such as displaying a graphical user interface including a team of the live event and the team's score during the live event. The information related to the live event can change as the live event progresses. For example, the estimates 175 may update or change as the live event progresses or odds information related to the live event changes.

The estimates 175 or the awards 170 can include the odds information as related to the live event. For example, the estimates 175 or the awards 170 can include information related to a likelihood of a team to win the live event, tie the live event, lose the live event, score a certain number of points, among others. The odds information related to the lineup entered into contests 155 can relate to or correspond to the determination of the estimate 175. For example, the selection of a fantasy sports lineup can update or generate odds associated with an outcome of a contest 155. In some implementations, a corresponding payout or award 170 can be determined based on several factors, including, but not limited to, the number of correct lineup entries a player makes, the number of players in each contest, and the distribution of lineups across contests 155 corresponding to events and/or live events.

In some implementations, the contests 155 can provide instructions for dynamic contest allocation and processing. In a brief overview of dynamic contest allocation and processing, the data processing system 105 can maintain a set of contests corresponding to one or more live sporting events. The data processing system 105 can receive a request identifying a player profile and fantasy sports lineup. The data processing system 105 can select a subset of contests in which the fantasy sports lineup is to be entered. The data processing system 105 can determine an estimated award for the lineup entered into the subset of contests. A player can select to enter the lineup into the subset of contests. The data processing system 105 can generate an award based on outcomes of live events associated with the subset of contests and entrants to the subset of contests.

Referring now to the operations of the data processing system 105, the contest maintainer 125 can maintain the one or more contests 155. Maintaining the contests 155 can include adding, removing, modifying, or altering the contests 155 as described herein. The contests 155 can be updated in real time or offline, prior to a scheduled live event. The contest maintainer 125 can update or modify entrance requirements of a contest. For example, the contest maintainer 125 can add, modify, remove, or change the quantity, rules, or number or types of seats associated with a contest. The contest maintainer 125 can update one or more contests 155 in response to at least a request from a client device (e.g., a client device 120), a periodic update (e.g., daily, weekly), a software update (e.g., from an external computing device, not pictured), an update from the data processing system 205 or its components (e.g., from the device communicator 130, the entrance determiner 135, the statistics manager 140, or the profile manager 145, among others), a change in a live event (e.g., a sports game being cancelled or postponed, an athlete being injured, a sports game progressing to overtime, etc.), or the determination of a tie.

The contest maintainer 125 can manage, maintain, or otherwise update contests 155 available for entry by a player. For example, the contest maintainer 125 can determine that an entry fee submitted by a player satisfies an entry fee for one or more contests 155. For example, the contest maintainer 155 can determine that a lineup generated by a player for entrance into a contest does not satisfy one or more rules for a lineup of the contest. In some cases, the contest maintainer 155 can make a contest unavailable to a player. For example, the contest maintainer 155 can make a contest unavailable to a player due to the elapse of a period of time, such as upon expiration of the contest (e.g., the elapse of a period of time associated with an opportunity to participate in the contest), or upon commencement of the contest. Due to the peer-to-peer nature of the contests 155, the contest maintainer 155 may make a contest unavailable to a particular player due to lineups entered by other players different than the particular player. For example, seats of a particular contest may be full (e.g., 100/100 seats of a contest are occupied by lineups generated by one or more other players operating respective sessions). In some cases, a lineup selected by a player can be automatically selected to be entered into a contest and can be provided, by the contest maintainer 155, a threshold period of time in which to confirm entrance of the generated lineup to the contest. Upon the expiration of the threshold period of time to confirm entrance, the contest maintainer 155 may release one or more seats selected by the player in which to enter a lineup in order to enable other players of the peer-to-peer contest system to enter the contest.

The device communicator 130 can establish a session with a client device (e.g., the client device 120) in response to a request from a client device. Establishing the session may include identifying the entries for the player profile 150 used to access the data processing system 105 to initiate a contest associated with one or more live events. The request to establish a contest session may include a request to participate in a contest, which may be received in one or more messages from an application executing on the client device 120. The message, or request, can indicate that a player intends to participate in a contest provided by the data processing system 105. The message can include an indication of a player profile 150 with which to use for the functionalities related to the game (e.g., submitting entry fees using earned credits, purchasing additional credits, etc.).

The message can include an identifier of a lineup generated by the player. In some implementations, the device communicator 130 can receive a selection of a fantasy sports lineup via the interactive elements 160. In some implementations, the device communicator 130 can provide the client device 120 with instructions to display one or more entries associated with the player profile 150 for selection to generate a lineup. In response to an interaction indicating a selection, the client device 120 can transmit a signal identifying a lineup to the data processing system 105. Using the line up, the data processing system 105 can generate a subset of the contests 155 based on the lineup and the contests 155 for the player to participate in.

The lineup can correspond to one or more one or more live event types such as a baseball game, soccer game, football game, tennis game, golf game, hockey game, mixed martial arts (MMA) match, game show, trivia game, awards show, spelling bee, or any other such event, sports game, match, or competition that has yet to occur or is occurring in real time. The messages and/or interactions transmitted by the client device 120 can include a selection of a lineup for entrance into contests 155. The selection of the lineup may include an indication of an entry fee for entering the lineup into one or more contests 155. In some cases, the request can indicate contests 155 related to a type of live event, such as a baseball game, soccer game, etc. The device communicator 130 can receive one or more entry fees from the client device 120 (e.g., in response to corresponding user interface elements presented at the client device 120, as described herein). The entry fee specified by the client device 120 can be a specified amount of credits, money, tickets, or other denominations. In some implementations, the player can specify a custom number or fractional number of credits used in each contest 155, each of which may correspond to a respective condition, outcome, or aspect of the game. In some implementations, the entry fees may include side entry fees, additional entry fees, or other entry fees submitted prior to or during a play of the game.

The entrance determiner 135 can select (or randomly select in some implementations) a subset of the contests 155 in which to enter the fantasy sports lineup. The subset of the contests 155 may be a subset of the contests 155 between which the entry fee will be divided. The entrance determiner 135 may select a subset of candidate contests for the player to enter the lineup into. The candidate contests may be potential contests which the player may enter the lineup into. The subset of contests 155 (e.g., candidate contests 155) may be a curated selection of contests 155 for the player to participate in by entering the lineup.

The entrance determiner 135 may select the subset of the contests based on the available contests 155 and the lineup. Available contests may refer to or include the contests 155 which still have seats for participants to enter into and which the lineup generated by the player corresponds to. For example, the lineup generated by the player may include entries corresponding to conditions met by baseball players during one or more live events. The available contests 155 corresponding to a baseball player lineup would include or correspond to baseball games. In some cases, the entrance determiner 135 may select the subset of contests based on entries in the lineup. In some implementations, one or more contests may correspond to a number or type of entry. The entrance determiner 135 may select the subset of contests 155 based on contests which the player is not already entered into. For example, the player may enter a first lineup into a first contest. Upon choosing a second lineup, the entrance determiner 135 may determine not to enter the second lineup into the first contest, or may prioritize contests which do not already have lineups entered that were generated by the player.

In some cases, selecting the subset of contests 155 can include selecting one or more seats for each contest in the subset. The entrance determiner 135 may select one or more seats for each contest 155 when selecting the subset of the contests. For example, the entrance determiner 135 may select five seats of a first contest and one seat of a second contest for inclusion in the subset of contests. In some cases, the entrance determiner 135 may select the subset of contests based on contests which the lineup is not already entered into. For example, the entrance determiner 135 may prioritize for selection contests which the entrance determiner 135 has not already selected one or more seats for inclusion in the subset of contests 155. In some cases, the entrance determiner 135 may select the seats of the contests in a round-robin approach. For example, the entrance determiner 135 may select the seats of the contests 155 for inclusion in the subset of contests by selecting a seat of each available contest until a seat of each available contest has been selected, and then selecting a subsequent seat of each available contest until a subsequent seat of each available contest has been selected. The entrance determiner 135 may repeat iteratively selecting seats of available contests for each contest until a cost of seat selection equals the entry fee, or until there are no more available seats. The entrance determiner 135 may select the seats at random, according to a sequence of contests 155, according to contests 155 which may produce a highest estimate 175, among others. In some implementations, contests 155 may be selected for the subset based on the time that the contests 155 are to stop receiving entries. For example, the entrance determiner 135 may prioritize contests that are will stop receiving entries soon and have not yet filled each seat in the contest 155 with possible entries.

Upon selection of seats, the statistics manager 140 may determine, for example, in some implementations, the estimate 175 for the subset of contests 155. The statistics manager 140 may determine the estimate 175 based on how players in past similar events performed. In some implementations, the estimate 175 may be determined further based on the lineup and other entrants to the subset of contests 155. The statistics manager 140 may determine the estimate 175 based on historical information relating to the lineup, the type of live event, the subset of contests 155 or similar contests, among others. In some implementations, the statistics manager 140 may identify odds information for possible outcomes of each entry in the lineup for contests 155 having similar attributes to those selected for inclusion in the subset of contests. The statistics manager 140 may identify the odds information by receiving the odds information from one or more servers. For example, the statistics manager 140 may receive the odds information associated with a live event from an outside computing device, server, or database. The statistics manager 140 may generate the odds information for each contest of the subset of contests 155 based on historical information related to the event type of the live event. The statistics manager 140 can maintain a data structure for each contest to store odd information for each contest.

The statistics manager 140 may generate the odds information based on an event type of the live event. The live event can include an event type. The event type may correspond to any attribute of a live event, such as a type of event such as sporting (e.g., hockey, football, basketball), game show (e.g., trivia, word-based, physical competition), or awards show (e.g., the Nobel Prize, the Pulitzer Prize, the Tony Awards). The event type may correspond to a duration of a live event (e.g., one hour, three hours), a location of a live event (e.g., events taking place in Spain, Texas, or London), or a team size of the live event (e.g., doubles tennis, a swimming medley relay). The statistics manager 140 can update the odds information associated with the contest based on several factors, including player interactions, random values, and occurrences within the live event. The statistics manager 140 may determine the odds information based on the type of entries within the lineup for the contest. For example, a first contest related to baseball can have entries associated with homeruns and a second contest related to football can have entries associated with rushing yards. Homeruns in baseball can be less likely to occur than rushing yards in football. The statistics manager 140 can update the odds information to reflect a lower likelihood for entries related to homeruns than for entries related to rushing yards.

In some cases, the statistics manager 140 may select a period of time for the historical information. The statistics manager 140 may select historical information of contests, lineups, or live events which occurred with the period or range of time. For example, the statistics manager 140 may select historical information occurring during one week, one month, or one year from a specified date. For example, the statistics manager may aggregate or analyze historical data from two weeks prior to a live event. The statistics manager 140 may select the period of time based on a type of the live event corresponding to the lineup. For example, if the live event is a hockey game on Oct. 15, 2050, the statistics manager may select the period of time as a month from Oct. 15, 2049-Dec. 15, 2049. Continuing with this example, the statistics manager 140 may select a period of time a year before instead of selecting a period of time immediately prior to the live event (e.g., September 1^{th}-October 14^{th}) because the regular National Hockey League (NHL) season does not begin in September. In this manner, the statistics manager 140 can select a period of time corresponding to the type of the event to provide relevant historical data for generating the estimate 175.

The statistics manager 140 may generate estimated outcomes for the live events indicated in the subset of contests 155. In some implementations, an estimated outcome for one or more live events can be determined using historical data from similar events. Similar events can be those that have the same number of participants, the same number of correct lineups (or lineup entries), or the same payout structure, among others. The historical data may include information about the number of players who participated in the similar event, the number of correct lineup entries made by each player, and the corresponding payouts awarded to each player. By analyzing the historical data, the statistics manager 140 can identify a payout distribution. For example, if a player makes five correct lineup entries for an event, the statistics manager 140 can use the payout distribution to determine the average payout for players who also made five correct lineup entries in similar events in the past. This average payout can then be used to generate an estimated outcome for a player's current event.

In some implementations, a corresponding payout can be determined based on several factors, including, but not limited to, the number of correct lineup entries a player makes, the number of players in each contest, and the distribution of lineups across contests corresponding to events and/or live events. In some implementations, the statistics manager 140 can determine the payout for a player based on the number of correct entries they make in a lineup. For example, the payout can be proportional to the number of correct entries in a lineup. In some implementations, the corresponding payout can be determined based on the number of correct picks in a lineup and results from historical contests. For example, the statistics manager 140 can determine that historical contest results for historic contests corresponding to the subset of contests indicate respective likelihoods of getting any particular number of selections for a lineup correct (e.g., one correct, two correct, three correct, four correct, five correct, six correct, etc.). Using this historical data, the statistics manager 140 can determine percentage of the contest pool that would be awarded for each of the subset of contests given the likelihoods of each number of correct selections. The statistics manager 140 can then sum the estimated award amounts for each contest to determine the estimate 175.

Additionally, in some implementations, in additional to or as an alternative to one or more approaches described herein, the statistics manager 140 can dynamically adjust the payout for a player based on the number of players who made the same number of correct entries in their respective lineups for one or more contests. For example, the payout can be divided evenly among all players who made the same number of correct lineup entries. In some implementations, the individual payout for a player can be inversely proportional to the number of other players who make the same number of correct lineup entries. In some implementations, the statistics manager 140 can randomly determine a total prize pool for a group of contests based on the wager amount placed by a player. A higher wager may grant access to a larger selection of contests for the player. In this regard, spreading a player's lineup entries across multiple contests can potentially yield a higher payout compared to concentrating all the lineup entries in a single contest.

In some implementations, based on the estimated outcomes of the live events, the statistics manager 140 may determine one or more estimated outcomes for the lineup within each of the subset of contests 155. For example, the statistics manager 140 may determine an estimated ranking, place, win, or loss for the player for the lineup for each of the subset of contests 155 based on the estimated outcomes of each of the live events corresponding to the subset of contests 155. The estimated outcomes for a live event can relate to events or subevents within the live event, such as a total points scored, points scored at a particular time of the live event, sub-events involving athletes within the live event (e.g., scores, fouls, runs, bench time, play time, injuries etc.), point spread between opposing teams, wins, losses, ties, progression to overtime events (e.g., shootouts, kickouts, overtime, etc.), among others. The estimated outcomes for a live event can correspond to an outcome for a lineup entered into a contest based on the live event. The estimated outcomes for the live event can correspond to a conditional event indicated in the lineup or entries of the lineup. For example, a lineup can include entries corresponding to athletes scoring a goal during the live event, points scored during the live event, or other such outcomes of the live event.

In some cases, the lineup can indicate one or more outcomes of the live events. For example, the lineup may indicate a number of athletes selected by the player as likely to score during a live event. Continuing with this example, the estimated outcome of the live event may indicate that only a subset of the lineup meets the criteria indicated (e.g., only a subset of the number of athletes selected is determined likely to score during the live event). In this illustrative example, the player will have won for the subset of players indicated in the lineup which match the subset of players estimated by the statistics manager 140 to meet the criteria indicated.

In some implementations, based on the estimated outcomes of the live events, the statistics manager 140 may generate the estimate 175 of the award. In some cases, the statistics manager 140 may generate the estimate 175 based on the estimated outcomes for the lineup and other entrants to the subset of contests 155. For example, other entrants may submit their own lineups to a contest 155 having a fixed award amount. The estimate 175 can be less than or equal to the fixed award amount for a particular contest 155. Depending on an estimated outcome for lineups of the entrants, the estimate 170 can be based on a division of the fixed award amount among winners of the contest 155. For example, for a particular contest 155, if 50 entrants win first place in the particular contest, a fixed value first place award can be split among the 50 entrants. In some cases, the award can be split proportionally to the number of seats owned by an entrant, as described herein. The statistics manager 140 may generate the estimate 175 based on outcomes for each entrant and corresponding lineup entered into the contest 155 thus far.

In some implementations, additional factors may be utilized to generate estimated outcomes for lineups. The statistics manager 140 may generate the estimated outcomes based on the odds information, such as the odds information received from a remote server, or the odds information generated based on the historical information. In some implementations, each lineup entered into a particular contest or group of contests by a respective player of a multitude of players can correspond to a respective estimate based on the totality of the lineups or a subset of the lineups entered into the particular contest or group of contests. That is to say, a first lineup in one or more contests can affect the estimate 175 corresponding to a second lineup. For example, if a first and second lineup are entered into a contest, the first contest may be predicted to win ⅗ picks (e.g., corresponding to entries or athletes in a lineup) correct, and the second contest may be predicted to win ⅖ picks correct. In this illustrative example, the first lineup would be estimated to win or have a higher estimated payout compared to the second lineup.

The client device 120 (or an application executing on the client device 120) can receive data relating to the outcomes from the device communicator 130, such as the estimates 175 for the selected lineup. The data relating to the requested game can include or may be generated based on the lineup, the estimate 170, the subset of contests 155, among others, which can be maintained by the statistics manager 140, as described herein. The device communicator 130 may determine updated information to provide to the client device 120 based on the estimate 170 for the game, which is initialized and updated by the statistics manager 140.

The statistics manager 140 may transmit the estimate 175 for presentation on the client device 120 by the device communicator 130. The device communicator 130 may generate instructions to generate a user interface presenting an indication of the estimate 175 to the player via the client device 120. The device communicator 130 can generate instructions for the client device 120 to display or update graphical user interfaces upon a display device of the client device 120. The device communicator 130 can include, in the instructions, positions, functions, sizes, animations, or other attributes associated with the graphical user interfaces and the interactive elements displayed therein. The device communicator 130 may present the indication of the estimate 175 with a listing of the subset of contests 155. In some cases, the device communicator 130 may present a graphical user interface element including the indication of the estimate. The graphical user interface element may include the listing of the subset of contests 155 or the entry fee input by the user. The device communicator 130 may present the indication of the estimate for the player to accept or reject. Upon rejection of the indication of the estimate, the device communicator 130 may remove the indication of the estimate. Upon acceptance of the indication of the estimate or the graphical user interface element, the entrance determiner 135 may submit the lineup for entrance into each of the subset of contests 155.

The entrance determiner 135 may enter the lineup into the subset of contests 155 upon receiving an acceptance of the indication of the estimate. In some cases, one or more contests of the subset of contests 155 selected by the entrance determiner 135 prior to presentation of the indication of the estimate may no longer be available. For example, one or more of the contests of the subset of contests 155 may have had their seats filled in the time between selection and acceptance by other entrants. In some cases, odds information associated with one or more of the contests may have changed such that one or more contests 155 of the subset of the contests 155 is no longer favorable for the lineup generated by the player.

In some cases, if one or more contests 155 of the subset of the contests 155 is no longer available upon acceptance of the graphical user interface element, the entrance determiner 135 may replace the one or more unavailable contests with available contests from the contests 155. The entrance determiner 135 may select the available contests to replace the unavailable contests in the manner described herein during the selection of the subset of the contests 155. In some implementations, if contests are not available for replacement, the entrance determiner 135 may instead modify the entrance fees provided for each selected contest 155 that can be entered. Indications of the contests 155 for which the lineup was entered can be provided to the client device 120 for display.

Upon completion of the live event relating to the contest, or upon the odds information indicating no change to an outcome of the live event, the statistics manager 140 may determine the award 170 for the lineup. The statistics manager 140 may determine the award 170 for each entrant of each contest based on the lineups entered by each entrant. The statistics manager 140 may determine the award 170 based on the outcomes associated with the live event, such as events within the live event or a final score of the live event. In some cases, the statistics manager 140 may receive the outcomes associated with the live event from an internal server, a remote server, or from a database. The statistics manager 140 may determine an award for each entrant of a particular contest by dividing a total fixed award amount of the particular contest among the entrants to the particular contest based on the outcomes of the live event and the lineups submitted by the entrants, as described herein. The statistics manager 140 may sum awards for each contest entered by a player with the lineup during the contest session to determine the award 170. The statistics manager 140 may calculate or determine a comparison of the estimate 175 and the award 170.

The device communicator may present the award to the player. The device communicator 130 may transmit funds associated with the award 170 to the player profile 150 identified in the request. The device communicator 130 may present the award 170 to the player via a user interface presenting on the client device 120. The device communicator 130 may present a comparison of the estimate and the award 170. In some cases, the device communicator 130 may present the estimate 175 generated prior to the commencement of the live event with an estimate 175′ (not pictured) generated during the commencement of the live event.

The profile manager 145 can create, modify, or delete player profiles 150 stored within storage 115. The profile manager 145 can handle the storage and organization of player information, including account details, preferences, and contest participation history, among others. The profile manager 145 can generate profile information based on data received from the client devices 120. This allows the profile manager 145 to capture activity across different contest applications and different devices, and store records of that activity in the player profile 150. The profile manager 145 can provide live event statistics (e.g., historical game outcomes), and contest statistics (e.g., historical contests or entry fees) to a requesting client device 120.

The profile manager 145 can update credit balances, game statistics, and other relevant information based on the outcomes of contests entered by a client device 120. The profile manager 145 receives data about live event results or contes results from the client devices 120 or the statistics manager 140 and uses this information to make adjustments to the player's profile 150. For example, if a player wins a live event contest with a $10 entry fee, the profile manager 145 would increase their credit balance by the corresponding amount (the amount of the entry fee plus the win). Similarly, the profile manager 145 can record game statistics such as the number of wins, losses, and ties, as well as the player's average entry fee amount, win percentage, and longest winning streak. This allows players to track their progress and review their contest history. For example, a player could see that they have a 60% win rate for contests relating to football and an average entry fee amount of $10. This information could help the player make better decisions about participating in contests in the future.

Referring now to FIG. 2A in the context of the components described in connection with FIG. 1, a graphical user interface 202 and a graphical user interface 204 are presented on a client device 120, for example, in response to a request for to participate in a contest. As discussed above, the device communicator 130 facilitates communication between the client device 120 and the data processing system 105, allowing players to interact with the graphical user interface 202 and transmit their actions to the data processing system 105. As players engage with the graphical user interface 202 or the graphical user interface 204, their actions, such as submitting entry fees or accepting a graphical user interface element listing contests and the entry fee, may be captured and stored in their player profile 150.

As depicted in FIG. 2A, the graphical user interface 202 displays a listing of potential entries for a lineup to be associated with the player profile 150. In some implementations, the entries can be associated with a card, tag, token, or NFT, among others, stored in association with the player profile 150. The player may select using, for example, the interactive elements 160, one or more entries for entrance into a fantasy sports lineup. The graphical user interface 204 displays a listing of entries selected for a lineup. In some implementations, and as shown here, selection of an entry can include a selection of more (e.g., “+”) or less (e.g., “−”) for the entry.

For example, an entry related to a selection of a team earning over or under a specified score can include a selection of the specified score. As an illustrative example, the player may select an entry corresponding to a score over a selected score. If, during the course of the live event or at the conclusion of the live event, the score of the live event exceeds the selected score, the entry is determined to win, or otherwise satisfy the criteria of the contest for that entry. Conversely, should the score of the live event not exceed the selected score, the entry would be determined to lose. Through the graphical user interface 204, the player may review their lineup. The graphical user interface 204 includes interactive elements 160 for inputting an entry fee. The player may select an entry fee amount by selecting one or more buttons or other interactive elements, or by typing (via a touch screen device or other user input coupled with the client device 120) an entry fee amount. The entry fee information is then transmitted from the client device 120 to the data processing system 105. The data processing system 105 receives and processes the entry fees. The player profile 150 is also updated with the entry fee information.

Referring now to FIG. 2B in the context of the components described in connection with FIG. 1, a graphical user interface 206 and a graphical user interface 208 are presented on a client device 120, for example, in response to selecting a lineup for entrance into contests. The graphical user interface 206 may display a listing of contests, such as a subset of the contests 155, into which the lineup may be entered. The graphical user interface 208 may display an estimated prize, such as the estimates 175, for different outcomes of the live events associated with the contest. The player may determine to submit their lineup to the automatically selected contests after reviewing the estimated prizes for the automatically selected contests.

Referring now to FIG. 2C in the context of the components described in connection with FIG. 1, a graphical user interface 210 and a graphical user interface 212 are presented on a client device 120, for example, in response to entering a lineup into the subset of contests. The graphical user interface 210 depicts an overview of contests associated with live events that one or more lineups of the player have been entered into. The graphical user interface 210 depicts different contests with different lineups, but it should be understood that different contests may have the same lineup entered, or the same contest may have different lineups entered into it. The graphical user interface 212 depicts an expanded view of a contest into which a player has entered a lineup. The expanded view depicts estimated prizing (e.g., estimates 175) vs. a guaranteed prize amount (e.g., the award 170). The graphical user interface 212 may be updated with different estimated prizing or guaranteed prize amounts as the live event associated with the contest progresses.

Referring to FIG. 2D in the context of the components described in connection with FIG. 1, illustrated is a graphical user interface 214 presented on the client device 120. The graphical user interface 214 may be an alternative implementation of the graphical user interfaces 202 and 204. For example, the graphical user interface 214 can depict a listing of entries from which the player can select to generate a lineup. The graphical user interface 214 can include a lineup that is being generated, displayed in a pane on the right-hand portion of the graphical user interface 214.

Referring now to FIG. 2E in the context of the components described in connection with FIG. 1, illustrated is a graphical user interface 216 and a graphical user interface 218 presented on the client device 120. The graphical user interface 214 may be an alternative implementation of the graphical user interface 208. For example, the graphical user interface 216 can depict estimated prizes for a selected lineup. From the graphical user interface 216, the player can select to enter the lineup into the subset of contests. Upon actuating a button labelled “View Contest Breakdown,” the graphical user interface 218 may display. The graphical user interface 218 may be an implementation of the graphical user interface 206. For example, the graphical user interface 218 can depict a listing of the subset of contests into which the lineup may be entered.

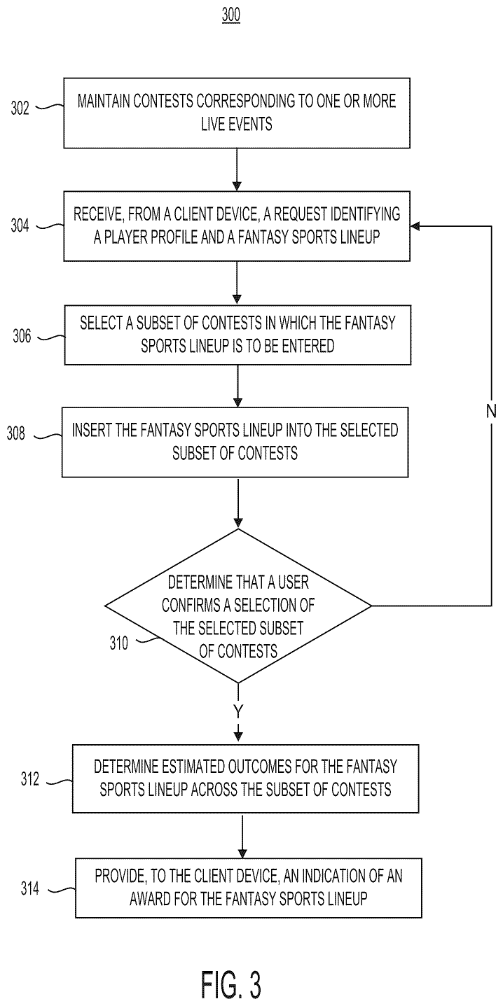

Referring now to FIG. 3, depicted is an illustrative flow diagram of a method 300 for dynamic contest processing. The method 300 can be executed, performed, or otherwise carried out by a contest server or contest system. A contest server (e.g., the data processing system 105) can be remote to one or more client devices and communicate with the one or more client devices via a computer network. In a brief overview of method 300, the data processing system (e.g., the data processing system 105) can maintain contests corresponding to one or more live events (STEP 302), receive from a client device a request identifying a player profile and a fantasy sports lineup (STEP 304), select a subset of contests in which the fantasy sports lineup is to be entered (STEP 306), insert the fantasy sports lineup into the selected subset of contests (STEP 308), determine whether a user confirms a selection of the selected subset of contests in which the fantasy sports lineup is entered (STEP 310), determine estimated/historical outcomes for the fantasy sports lineup across the subset of contests in response to the user confirming the selection (STEP 312), and provide to the client device an indication of an award for the fantasy sports lineup (STEP 314).

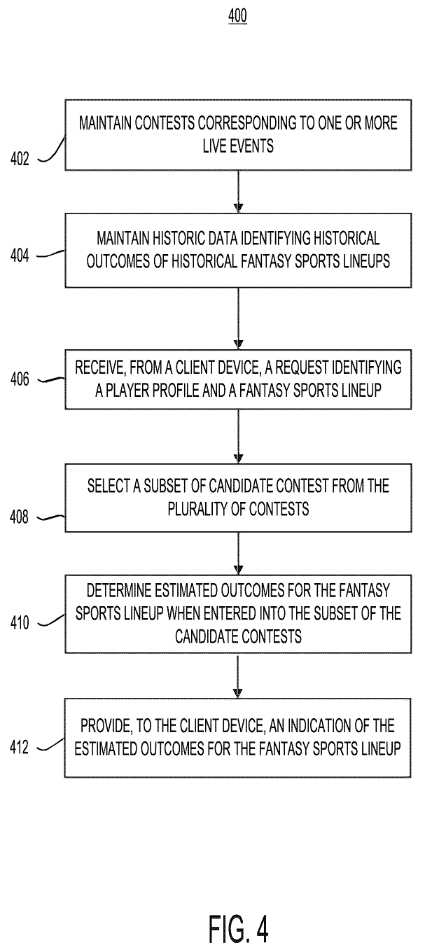

Referring now to FIG. 4, depicted is an illustrative flow diagram of a method 400 for dynamic contest allocation. The method 400 can be executed, performed, or otherwise carried out by a contest server or contest system. A contest server (e.g., the data processing system 105) can be remote to one or more client devices and communicate with the one or more client devices via a computer network. In a brief overview of method 400, the data processing system (e.g., the data processing system 105) can maintain contests corresponding to one or more live events (STEP 402), maintain historic data identifying historical outcomes of historical fantasy sports lineups (STEP 404), receive, from a client device, a request identifying a player profile and a fantasy sports lineup (STEP 406), select a subset of candidate contests from the plurality of contests (STEP 408), determine estimated outcomes for the fantasy sports lineup when entered into the subset of the candidate contests (STEP 410), and provide to the client device an indication of the estimated outcomes for the fantasy sports lineup (STEP 412).

Various operations described herein can be implemented on computer systems. FIG. 5 shows a simplified block diagram of a representative server system 500, client computer system 514, and network 526 usable to implement certain implementations of the present disclosure. In various implementations, server system 500 or similar systems can implement services or servers described herein or portions thereof. Client computer system 514 or similar systems can implement clients described herein. The system (e.g., the data processing system 105) and others described herein can be similar to the server system 500.

Server system 500 can have a modular design that incorporates a number of modules 502; while two modules 502 are shown, any number can be provided. Each module 502 can include processing unit(s) 504 and local storage 506.

Processing unit(s) 504 can include a single processor, which can have one or more cores, or multiple processors. In some implementations, processing unit(s) 504 can include a general-purpose primary processor as well as one or more special-purpose co-processors such as graphics processors, digital signal processors, or the like. In some implementations, some or all processing units 504 can be implemented using customized circuits, such as application specific integrated circuits (ASICs) or field programmable gate arrays (FPGAs). In some implementations, such integrated circuits execute instructions that are stored on the circuit itself. In other implementations, processing unit(s) 504 can execute instructions stored in local storage 506. Any type of processors in any combination can be included in processing unit(s) 504.

Local storage 506 can include volatile storage media (e.g., DRAM, SRAM, SDRAM, or the like) and/or non-volatile storage media (e.g., magnetic or optical disk, flash memory, or the like). Storage media incorporated in local storage 506 can be fixed, removable or upgradeable as desired. Local storage 506 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 504 need at runtime. The ROM can store static data and instructions that are needed by processing unit(s) 504. The permanent storage device can be a non-volatile read-and-write memory device that can store instructions and data even when module 502 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some implementations, local storage 506 can store one or more software programs to be executed by processing unit(s) 504, such as an operating system and/or programs implementing various server functions such as functions of the data processing systems 105 of FIG. 1 or any other system described herein, or any other server(s) associated with the data processing systems 105, or any other system described herein.

“Software” refers generally to sequences of instructions that, when executed by processing unit(s) 504 cause server system 500 (or portions thereof) to perform various operations, thus defining one or more specific machine implementations that execute and perform the operations of the software programs. The instructions can be stored as firmware residing in read-only memory and/or program code stored in non-volatile storage media that can be read into volatile working memory for execution by processing unit(s) 504. Software can be implemented as a single program or a collection of separate programs or program modules that interact as desired. From local storage 506 (or non-local storage described below), processing unit(s) 504 can retrieve program instructions to execute and data to process in order to execute various operations described above.

In some server systems 500, multiple modules 502 can be interconnected via a bus or other interconnect 508, forming a local area network that supports communication between modules 502 and other components of server system 500. Interconnect 508 can be implemented using various technologies including server racks, hubs, routers, etc.

A wide area network (WAN) interface 510 can provide data communication capability between the local area network (interconnect 508) and the network 526, such as the

Internet. Technologies can be used, including wired (e.g., Ethernet, IEEE 802.3 standards) and/or wireless technologies (e.g., Wi-Fi, IEEE 802.11 standards).

In some implementations, local storage 506 is intended to provide working memory for processing unit(s) 504, providing fast access to programs and/or data to be processed while reducing traffic on interconnect 508. Storage for larger quantities of data can be provided on the local area network by one or more mass storage subsystems 512 that can be connected to interconnect 408. Mass storage subsystem 512 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 512. In some implementations, additional data storage resources may be accessible via WAN interface 510 (potentially with increased latency).

Server system 500 can operate in response to requests received via WAN interface 510. For example, one of modules 502 can implement a supervisory function and assign discrete tasks to other modules 502 in response to received requests. Work allocation techniques can be used. As requests are processed, results can be returned to the requester via WAN interface 510. Such operation can generally be automated. Further, in some implementations, WAN interface 510 can connect multiple server systems 500 to each other, providing scalable systems capable of managing high volumes of activity. Techniques for managing server systems and server farms (collections of server systems that cooperate) can be used, including dynamic resource allocation and reallocation.

Server system 500 can interact with various user-owned or user-operated devices via a wide-area network such as the Internet. An example of a user-operated device is shown in FIG. 5 as client computing system 514. Client computing system 514 can be implemented, for example, as a consumer device such as a smartphone, other mobile phone, tablet computer, wearable computing device (e.g., smart watch, eyeglasses), desktop computer, laptop computer, and so on.

For example, client computing system 514 can communicate via WAN interface 510. Client computing system 514 can include computer components such as processing unit(s) 516, storage device 518, network interface 520, user input device 522, and user output device 524. Client computing system 514 can be a computing device implemented in a variety of form factors, such as a desktop computer, laptop computer, tablet computer, smartphone, other mobile computing device, wearable computing device, or the like.

Processor 516 and storage device 518 can be similar to processing unit(s) 504 and local storage 506 described above. Suitable devices can be selected based on the demands to be placed on client computing system 514; for example, client computing system 514 can be implemented as a “thin” client with limited processing capability or as a high-powered computing device. Client computing system 514 can be provisioned with program code executable by processing unit(s) 516 to enable various interactions with server system 500 of a message management service such as accessing messages, performing actions on messages, and other interactions described above. Some client computing systems 514 can also interact with a messaging service independently of the message management service.

Network interface 520 can provide a connection to the network 526, such as a wide area network (e.g., the Internet) to which WAN interface 510 of server system 500 is also connected. In various implementations, network interface 520 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 522 can include any device (or devices) via which a user can provide signals to client computing system 514; client computing system 414 can interpret the signals as indicative of particular user requests or information. In various implementations, user input device 522 can include any or all of a keyboard, touch pad, touch screen, mouse or other pointing device, scroll wheel, click wheel, dial, button, switch, keypad, microphone, and so on.

User output device 524 can include any device via which client computing system 514 can provide information to a user. For example, user output device 524 can include a display to display images generated by or delivered to client computing system 514. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some implementations can include a device such as a touchscreen that function as both input and output device. In some implementations, other user output devices 524 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 504 and 516 can provide various functionality for server system 500 and client computing system 514, including any of the functionality described herein as being performed by a server or client, or other functionality associated with message management services.

It will be appreciated that server system 500 and client computing system 514 are illustrative and that variations and modifications are possible. Computer systems used in connection with implementations of the present disclosure can have other capabilities not specifically described here. Further, while server system 500 and client computing system 514 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor can receive instructions and data from a read-only memory or a random access memory or both. The elements of a computer include a processor for performing actions in accordance with instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a player, implementations of the subject matter described in this specification can be implemented on a computer having a display device, e.g., a CRT (cathode ray tube), plasma, or LCD (liquid crystal display) monitor, for displaying information to the player and a keyboard and a pointing device, e.g., a mouse or a trackball, by which the player can provide input to the computer. Other kinds of devices can be used to provide for interaction with a player as well; for example, feedback provided to the player can include any form of sensory feedback, e.g., visual feedback, auditory feedback, or tactile feedback; and input from the player can be received in any form, including acoustic, speech, or tactile input. In addition, a computer can interact with a player by sending documents to and receiving documents from a device that is used by the player; for example, by sending web pages to a web browser on a player's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a player can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as the system described herein can include clients and servers. For example, the system can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a player interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the system could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence has any limiting effect on the scope of any claim elements.

The systems and methods described herein may be embodied in other specific forms without departing from their characteristics thereof. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced there.

What is claimed is:

1. A system, comprising:
one or more processors coupled to non-transitory memory, the one or more processors configured to:
maintain a plurality of contests corresponding to one or more live sporting events;
receive, from a client device, a request identifying a player profile and a fantasy sports lineup;
select, based on the plurality of contests and the fantasy sports lineup, a subset of the plurality of contests in which the fantasy sports lineup is to be entered;
determine an outcome for the fantasy sports lineup across the subset of contests based on corresponding outcomes of the one or more live sporting events and corresponding entrants for the subset of contests; and
provide, to the client device, an indication of an award amount for the fantasy sports lineup determined based on the outcome.

2. The system of claim 1, wherein in receiving the request identifying the player profile and the fantasy sports lineup, the one or more processors are configured to receive an indication of an entry amount corresponding to the fantasy sports lineup.

3. The system of claim 2, wherein the one or more processors are configured to associate a portion of the entry amount with each contest of the subset of contests.

4. The system of claim 1, wherein in selecting the subset of the plurality of contests in which the fantasy sports lineup is to be entered, the one or more processors are configured to identify the subset of the plurality of contests based on existing contest entries identified in the player profile, available contests of the plurality of contests, and the fantasy sports lineup.

5. The system of claim 1, wherein the one or more processors are configured to determine the outcome based on a plurality of lineup entries entered into the subset of contests.

6. The system of claim 1, wherein the one or more processors are configured to provide, to the client device for display, an indication of an estimated award amount responsive to selecting the subset of the plurality of contests.

7. The system of claim 6, wherein the one or more processors are configured to determine the estimated award amount based on historic data identifying a plurality of historical outcomes of a plurality of historical fantasy sports lineups.

8. The system of claim 6, wherein the one or more processors are configured to:
determine a change to the estimated award amount based on an occurrence of one or more live events; and
update the presented indication of the estimated award amount based on the change.

9. The system of claim 6, wherein the one or more processors are configured to:
present a graphical user interface element comprising the indication of the estimated award amount; and
receive a selection indicating acceptance of the estimated award amount from the client device.

10. The system of claim 1, wherein the one or more processors are configured to receive the corresponding outcomes of the one or more live sporting events from one or more servers.

11. The system of claim 1, wherein the one or more processors are configured to select the subset of the plurality of contests based on an event type of the live event.

12. The system of claim 1, wherein the one or more processors are configured to:
maintain a data structure storing an award estimated amount for a respective outcome of a respective entry of a plurality of entries identified in the lineup; and
populate a graphical user interface coupled with the client device using the data structure.

13. A method, comprising:
maintaining, by one or more processors coupled to non-transitory memory, a plurality of contests corresponding to one or more live sporting events;
receiving, by the one or more processors from a client device, a request identifying a player profile and a fantasy sports lineup;
selecting, by the one or more processors, based on the plurality of contests and the fantasy sports lineup, a subset of the plurality of contests in which the fantasy sports lineup is to be entered;
determining, by the one or more processors, an outcome for the fantasy sports lineup across the subset of contests based on corresponding outcomes of the one or more live sporting events and corresponding entrants for the subset of contests; and
providing, by the one or more processors to the client device, an indication of an award amount for the fantasy sports lineup determined based on the outcome.

14. The method of claim 12, wherein receiving the request identifying the player profile and the fantasy sports lineup comprises receiving, by the one or more processors, an entry amount corresponding to the fantasy sports lineup.

15. The method of claim 12, wherein selecting the subset of the plurality of contests in which the fantasy sports lineup is to be entered comprises identifying, by the one or more processors, the subset of the plurality of contests based on existing contest entries by the player, available contests, and the fantasy sports lineup.

16. The method of claim 12, comprising presenting, by the one or more processors, on a display coupled with the client device, an indication of an estimated award amount, responsive to selecting the subset of the plurality of contests.

17. The method of claim 16, comprising determining, by the one or more processors, the estimated award amount based on historic data identifying a plurality of historical outcomes of a plurality of historical fantasy sports lineups.

18. The method of claim 16, comprising:
determining, by the one or more processors, a change to the estimated award amount based on an occurrence of one or more live events; and
updating, by the one or more processors, the presented indication of the estimated award amount based on the change.

19. The method of claim 17, comprising:
presenting, by the one or more processors, a graphical user interface element comprising the indication of the estimated award amount; and
receiving, by the one or more processors, a selection indicating acceptance of the estimated award amount from the client device.

20. The method of claim 12, comprising receiving, by the one or more processors, the corresponding outcomes of the one or more live sporting events from one or more servers.

21. A system, comprising:
one or more processors coupled to non-transitory memory, the one or more processors configured to:
maintain a plurality of contests corresponding to one or more live sporting events;
maintain historic data identifying a plurality of historical outcomes of a plurality of historical fantasy sports lineups;
receive, from a client device, a request identifying a player profile and a fantasy sports lineup;
select, based on the plurality of contests and the fantasy sports lineup, a subset of candidate contests from the plurality of contests;
determine, based on the historic data, a plurality of estimated outcomes for the fantasy sports lineup when entered into the subset of the candidate contests; and
provide, to the client device, an indication of the plurality of estimated outcomes for the fantasy sports lineup.

22. The system of claim 21, wherein the one or more processors are configured to determine the plurality of estimated outcomes for the fantasy sports lineup based on the historic data and a plurality of lineups entered into each contest of the subset of the candidate contests.

23. The system of claim 21, wherein in receiving the request identifying the player profile and the fantasy sports lineup, the one or more processors are configured to receive an entry amount corresponding to the fantasy sports lineup.

24. The system of claim 23, wherein the one or more processors are configured to associate a portion of the entry amount with each contest of the subset of the candidate contests.

25. The system of claim 21, wherein in selecting the subset of the candidate contests of the plurality of contests in which the fantasy sports lineup is to be entered, the one or more processors are configured to
identify the subset of the candidate contests of the plurality of contests based on existing contest entries identified in the player profile, available contests of the plurality of contests, and the fantasy sports lineup.

26. The system of claim 21, wherein the one or more processors are configured to:
determine the plurality of estimated outcomes based on historic lineups entered into a set of historic contests corresponding to the subset of contests; and
determine a corresponding payout based on the plurality of estimated outcomes.

27. The system of claim 21, wherein the one or more processors are configured to:
determine a change to the plurality of estimated outcomes based on an occurrence of one or more live events; and
update the indication of the plurality of estimated outcomes based on the change.

28. The system of claim 21, wherein the one or more processors are configured to:
present a graphical user interface element comprising the indication of the plurality of estimated outcomes; and
receive a selection indicating acceptance of the plurality of estimated outcomes from the client device.

29. The system of claim 21, wherein the one or more processors are configured to receive historic data from one or more servers.

30. The system of claim 21, wherein the one or more processors are configured to select the subset of candidate contests from the plurality of contests based on an event type of the live event.

31. A method, comprising:
maintaining, by one or more processors coupled with memory, a plurality of contests corresponding to one or more live sporting events;
maintaining, by the one or more processors, historic data identifying a plurality of historical outcomes of a plurality of historical fantasy sports lineups;
receiving, by the one or more processors from a client device, a request identifying a player profile and a fantasy sports lineup;
selecting, by the one or more processors, based on the plurality of contests and the fantasy sports lineup, a subset of candidate contests from of the plurality of contests;
determining, by the one or more processors, based on the historic data, a plurality of estimated outcomes for the fantasy sports lineup when entered into the subset of the candidate contests; and
providing, by the one or more processors, to the client device, an indication of the plurality of estimated outcomes for the fantasy sports lineup.

32. The method of claim 31, comprising determining, by the one or more processor, the plurality of estimated outcomes for the fantasy sports lineup based on the historic data and a plurality of entrants for each contest of the subset of the candidate contests.

33. The method of claim 31, wherein receiving the request identifying the player profile and the fantasy sports lineup, comprises receiving, by the one or more processors, an entry amount corresponding to the fantasy sports lineup.

34. The method of claim 31, comprising associating, by the one or more processors, a portion of the entry amount with each contest of the subset of the candidate contests.

35. The method of claim 31, wherein selecting the subset of the candidate contests of the plurality of contests in which the fantasy sports lineup is to be entered comprises identifying, by the one or more processors, the subset of the candidate contests of the plurality of contests based on existing contest entries identified in the player profile, available contests of the plurality of contests, and the fantasy sports lineup.

36. The method of claim 31, comprising determining, by the one or more processors, the plurality of estimated outcomes based on a plurality of lineups of corresponding entrants for the subset of contests.

37. The method of claim 31, comprising:
determining, by the one or more processors, a change to the plurality of estimated outcomes based on an occurrence of one or more live events; and
updating, by the one or more processors, the indication of the plurality of estimated outcomes based on the change.

38. The method of claim 31, comprising:
presenting, by the one or more processors, a graphical user interface element comprising the indication of the plurality of estimated outcomes; and
receiving, by the one or more processors, a selection indicating acceptance of the plurality of estimated outcomes from the client device.

39. The method of claim 31, comprising receiving, by the one or more processors, historic data from one or more servers.

40. The method of claim 31, comprising selecting, by the one or more processors, the subset of candidate contests from the plurality of contests based on an event type of the live event.
